(19) United States
(12) Patent Application Publication
(10) Pub. No.: US 2008/0174613 A1
(43) Pub. Date: Jul. 24, 2008

(54) ACTIVE MATRIX DISPLAY DEVICE

(76) Inventor: Kazuyoshi Kawabe, Yokohama (JP)

Correspondence Address: Frank Pincelli;Patent Legal Staff, Eastman Kodak Company, 343 State Street, Rochester, NY, 14650-2201, US

(21) Appl. No.: 12/013,495

(22) Filed: Jan. 14, 2008

(30) Foreign Application Priority Data
Jan. 23, 2007 (JP) 2007-012910

(51) Int. Cl. G09G 5/10; G09G 3/20; G09G 3/30

(52) U.S. Cl. 345/690; 345/55; 345/76

(57) ABSTRACT

A scanning driver is described which sequentially selects a selection line of each row. A storage unit stores data for setting an arbitrary region in which display is to be updated. Only an output of the selection driver in the region which is set by the storage unit is activated, and only data corresponding to that region is supplied to the corresponding pixels.

### CROSS-REFERENCE TO RELATED APPLICATION

This application claims priority of Japanese Patent Application No. 2007-012910 filed Jan. 23, 2007 which is incorporated herein by reference in its entirety.

### FIELD OF THE INVENTION

The present invention relates to an active matrix display device having a sequentially scanning selection driver.

### BACKGROUND OF THE INVENTION

Display panels having an organic electroluminescence (hereinafter simply referred to as “EL”) element as a light emitting element are known, and are becoming more widely available as thin display devices. There are passive organic EL display devices and active (active matrix) EL display devices. Of these, because an active matrix EL display device in which a thin film transistor is provided in each pixel and display is controlled can achieve display of a higher resolution, the active matrix EL display devices are becoming more popular.

An organic EL element is a current-driven element. In order to control the amount of light emission with analog data, a driving transistor in which the amount of current is controlled according to a data voltage is provided in each pixel. However, it is difficult to inhibit variation in characteristics of the driving transistors, and allow an appropriate current to always flow through the driving transistor according to the data voltage.

For this purpose, a method is proposed in which the active matrix organic EL panel is digitally driven (refer to WO 2005/116971). With digital driving, the amount of light emission at each pixel may be constant, and the influences of the characteristic variation of driving transistors can be inhibited.

The above-described reference (WO 2005/116971) discloses a method of digital driving using a sequentially scanning selection driver (gate driver) which sequentially selects gate lines one by one using a shift register. The sequentially scanning gate driver, however, has a smaller degree of freedom regarding a selection method of a gate line compared to a randomly scanning gate driver, in which a circuit which can select an arbitrary gate line such as a decoder is provided.

For example, when it is desired to limit a multiple grayscale display region to a certain region, the region can easily be limited in a randomly scanning gate driver because an arbitrary gate line can be accessed. In the sequentially scanning gate driver, on the other hand, because the lines must be scanned in order from top to bottom, if the line to be accessed is at a position between the topmost line and the bottommost line, gate lines which do not need to be accessed are also selected.

Therefore, from this viewpoint, the randomly scanning gate driver appears more desirable. When, on the other hand, the entire screen is to be updated, a value for designating a selection line must be sequentially added and updated in the randomly scanning gate driver, and thus the process is complicated. In addition, when the number of gate lines to be selected is increased, the size of the decoder circuit is also increased and the operation speed is reduced, and thus the randomly scanning gate driver is not suited to increasing the resolution.

In the sequentially scanning gate driver, on the other hand, even when the entire screen is to be updated, the shift register can transfer the selection signal, and consequently the selection line can be updated by merely supplying a clock, and thus the update process is simple. In addition, even when the number of gate lines to be selected is increased, it is only necessary to add a shift register and the operation speed is not constrained, and thus the sequentially scanning gate driver is suited to increasing the resolution.

As described, the randomly scanning gate driver has a higher degree of freedom in selection of a gate line but is disadvantageous in terms of the circuit size and operation speed, while a disadvantage of the sequentially scanning gate driver is that the degree of freedom of selection is small.

### SUMMARY OF THE INVENTION

According to one aspect of the present invention, there is provided an active matrix display device having a plurality of pixels arranged in a matrix form and in which data is supplied to a data line of each column by a data driver, wherein data capturing from a data line in a pixel of each row is controlled by controlling a selection line by an output of a selection driver, to supply data to each pixel and realize display, and wherein the selection driver is a sequentially scanning driver which sequentially selects the selection line of each row, and includes a storage unit which stores data for setting an arbitrary region in which a multiple grayscale display is to be realized, and a controller which controls output of the selection driver by the storage unit, and data for setting a region in which display is to be updated are stored in the storage unit prior to starting the update of the display, and only outputs of the selection driver for the set region are activated and data are supplied to the pixels.

According to another aspect of the present invention, it is preferable that, in the active matrix display device, data supplied to the data line is digital data, and a multiple grayscale display is realized in the region in which the display is to be updated.

According to another aspect of the present invention, it is preferable that, in the active matrix display device, the storage unit includes a register which stores data corresponding to each selection line, and the controller includes a gate which activates or deactivates an output from the selection driver to a corresponding selection line according to data in each register.

According to another aspect of the present invention, it is preferable that, in the active matrix display device, the storage unit is a shift register, and data is sequentially transferred and set in a register corresponding to each selection line.

According to another aspect of the present invention, it is preferable that, in the active matrix display device, each pixel includes a static memory, and can retain data which is written.

According to another aspect of the present invention, it is preferable that, in the active matrix display device, each pixel includes an organic electroluminescence element as a light emitting element.

According to various aspects of the present invention, a region of a display device in which display is to be updated can be set using a storage unit. Therefore, it is possible to easily achieve a multiple grayscale display only in a certain region through digital driving using a sequentially scanning selection driver.

### BRIEF DESCRIPTION OF THE DRAWINGS

Preferred embodiments of the present invention will be described in detail by reference to the drawings, wherein:

FIG. 1A is an equivalent circuit diagram of a pixel in which a static memory is provided;

FIG. 1B is a diagram showing placement and connection in a pixel in which a static memory is provided;

FIG. 2 is an overall structural diagram of an organic electroluminescence display;

FIG. 3 is a diagram showing an internal structure of a data driver;

FIG. 4 is a structural diagram of a gate driver according to a preferred embodiment of the present invention; and

FIG. 5 is a diagram for explaining a partial update process.

### DESCRIPTION OF THE PREFERRED EMBODIMENTS

A preferred embodiment of the present invention will now be described referring to the drawings.

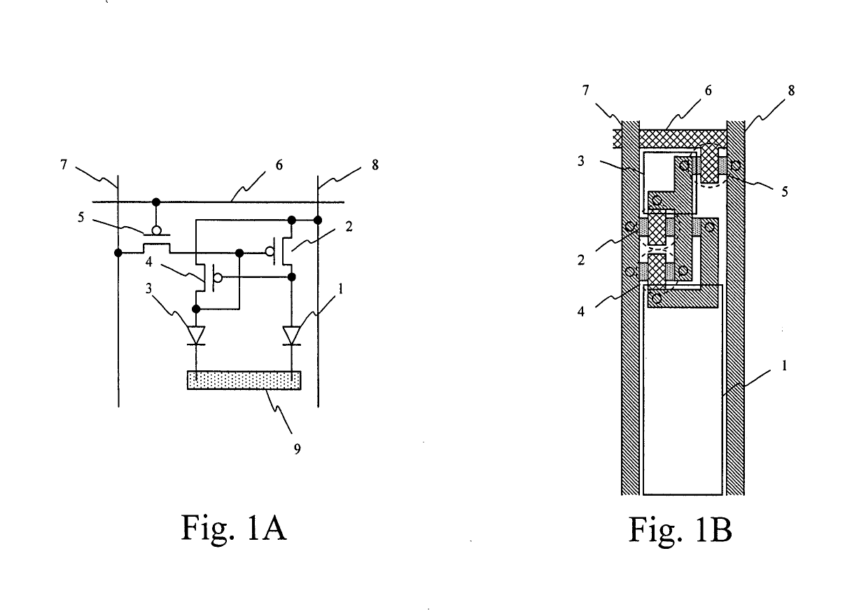

FIGS. 1A and 1B show a structure of a pixel circuit in which a static memory is introduced in a pixel circuit. FIG. 1A is an equivalent circuit diagram of the pixel and FIG. 1B is a diagram showing placement and connection in the pixel circuit seen from a side opposite to the light emission surface.

A pixel in FIGS. 1A and 1B includes a first organic electroluminescence (“EL”) element 1 which contributes to light emission, a first driving transistor 2 which drives the first organic EL element 1, a second organic EL element 3 which does not contribute to light emission, a second driving transistor 4 which drives the second organic EL element 3, and a gate transistor 5 which controls supply, with a gate line 6 to which a selection signal is supplied, of a data voltage supplied on a data line 7 to a gate terminal of the first driving transistor 2. In this example configuration, the first driving transistor 2, the second driving transistor 4, and the gate transistor 5 are p-channel transistors.

An anode of the first organic EL element is connected to a drain terminal of the first driving transistor 2 and to a gate terminal of the second driving transistor 4. A gate terminal of the first driving transistor 2 is connected to an anode of the second organic EL element 3, to a drain terminal of the second driving transistor 4, and to a source terminal of the gate transistor 5. A gate terminal of the gate transistor 5 is connected to a gate line 6 and the drain terminal of the gate transistor 5 is connected to the data line 7. Source terminals of the first driving transistor 2 and the second driving transistor 4 are connected to a power supply line 8, and cathodes of the first organic EL element 1 and the second organic EL element 3 are connected to a cathode electrode 9.

In a pixel having such a structure, when the gate line 6 is selected (when gate line 6 is set at a Low level), the gate transistor 5 is switched ON, and a data voltage supplied on the data line is read into the pixel circuit through the gate transistor 5. When the data voltage is Low, the first driving transistor 2 is switched ON. When the first driving transistor 2 is switched ON, the anode of the first organic EL element 1 is connected to the power supply line 8 on which a power supply voltage VDD is supplied, a current flows through the first organic EL element 1, and light is emitted. At the same time, the gate terminal of the second driving transistor 4 is also set at VDD, the second driving transistor 4 is switched OFF, and a potential of the anode of the second organic EL element 3 is dropped to a cathode potential VSS. Because the cathode potential VSS is supplied to the gate terminal of the first driving transistor 2, the written data Low is continued to be maintained while VDD and VSS are being supplied, even after the gate line 6 is set at High and the gate transistor 5 is switched OFF.

When the data voltage is High, the first driving transistor 2 is switched OFF and the potential of the anode of the first organic EL element 1 is dropped to the cathode potential VSS. Because the cathode potential VSS is supplied to the gate terminal of the second driving transistor 4, the second driving transistor 4 is switched ON, the anode of the second organic EL element 3 is connected to the power supply line 8 on which the power supply voltage VDD is supplied, and a current flows through the second organic EL element 3. The anode potential of the second organic EL element 3 is reflected in the gate terminal of the first driving transistor 2, and the gate terminal of the first driving transistor 2 is set to the power supply voltage VDD. Thus, even after the gate line 6 is set to High and the gate transistor 5 is switched OFF, the written data High is maintained while VDD and VSS are being supplied.

As described, in the pixel of FIGS. 1A and 1B, data is stored in a static memory including the first driving transistor 2 and the second driving transistor 4, and light emission from the first organic EL element 1 is controlled with the static memory. Therefore, because the data is maintained after the data is written, a refresh operation to periodically rewrite data at a predetermined period is not necessary. In the pixel of FIGS. 1A and 1B, because the second organic EL element 3 does not contribute to light emission, the light emission state of the pixel is determined by the light emission state of the first organic EL element 1.

As a method of forming the second organic EL element 3 which does not contribute to light emission, there is a method of forming an element which does not emit light and which differs from the first organic EL element 1. In this method, however, because two elements including the first organic EL element 1 which emits light and the organic EL element 3 which does not emit light must be formed, the manufacturing process becomes complicated. Alternatively, the second organic EL element 3 can be easily formed by forming the first and second organic EL elements as elements of the same structure, and blocking light with a line forming a part of the pixel circuit or with a black matrix so that the light is not emitted to the outside from the light emission surface.

With either method, because the second organic EL element 3 does not contribute to light emission, it is preferable to place and connect the second organic EL element 3 with a small area so that a large light emission area can be secured for the first organic EL element 1 which emits light, as shown in FIG. 1B.

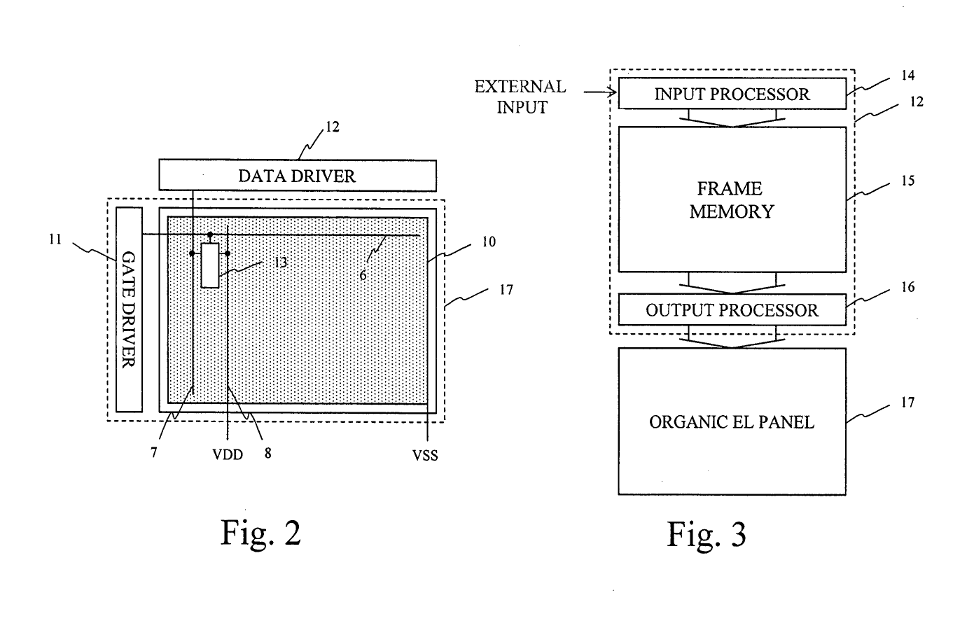

FIG. 2 shows an overall structure of an organic EL display including a pixel memory array 10 in which pixels 13 of FIG. 1 are arranged in a matrix form, a gate driver (selection driver) 11 which drives a gate line 6 provided for each row, and a data driver 12 which drives a data line 7 provided for each column. The power supply line 8 and the cathode electrode 9 are shared by all pixels, and VDD and VSS are supplied from the outside, respectively.

When a high-performance transistor which is manufactured through a process using low temperature polysilicon, for example, is used, the gate driver 11 and the data driver 12 can be formed on a same glass substrate as the pixel 13. However, in a digital driving, because a frame memory is required for dividing a frame video image into a plurality of sub-frames, it is preferable to form the data driver 12 as a driver IC and form the gate driver 11 on the same glass substrate as the pixel 13.

FIG. 3 shows an internal structure of the data driver 12. Input data which is input to an input processor 14 from an external input is video data having, for a case of a full-color display, red (R), green (G) and blue (B), or red (R), green (G), blue (B) and white (W), and which is transferred in units of a pixel or a few pixels, and a clock signal, a timing signal, or the like for transferring the video data. The video data in the input data is accumulated as video data of one line (one row) at the input processor 14 and is stored in the frame memory 15 in units of lines. The video data of one screen stored in the frame memory 15 is read in units of lines, and is output to the organic EL panel 17 by an output processor 16 in units of lines. The organic EL panel 17 reflects the supplied video data on the display. Here, the timing signal for storage to the frame memory 15 and timing signals for reading and outputting to the organic EL panel 17 will not be described.

In the structure having a frame memory 15 introduced between the input processor 14 and the output processor 16 in this manner, because the video data can be supplied from the frame memory 15 to the organic EL panel 17 without inputting the video data from the outside once the video data is stored in the frame memory 15, it is not necessary to continue to input the video data from the outside. In other words, power consumption necessary for data transfer from the outside can be reduced, and thus such a configuration is often used in an LCD (Liquid Crystal Display) equipped in a portable terminal which requires reduction of power consumption.

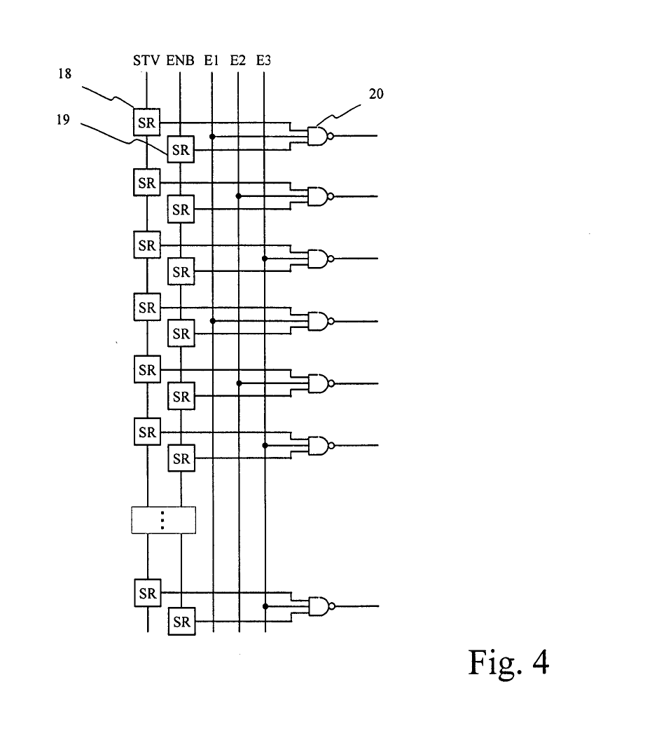

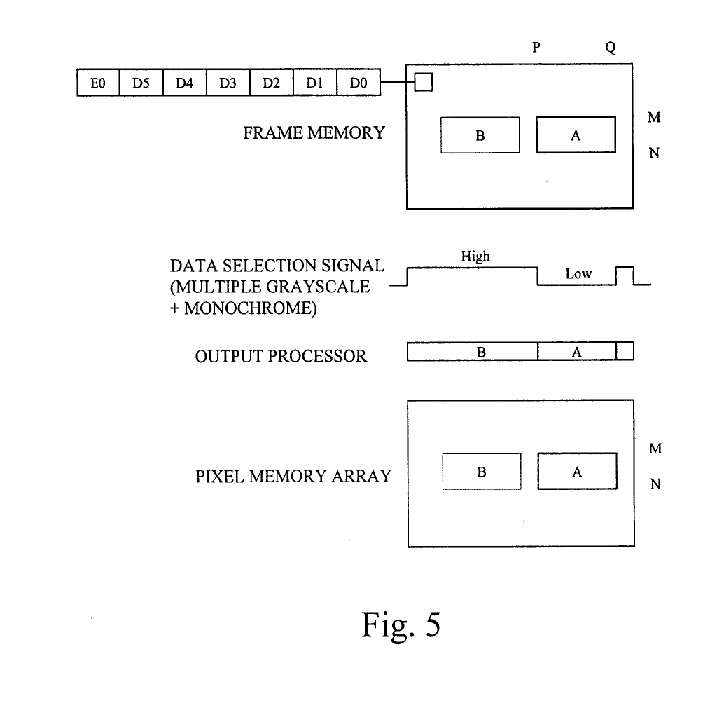

In the case of digital driving, because the sub-frame data is updated in units of a screen in each sub-frame period, the power consumption due to scanning is increased. By introducing a static memory which does not require refreshing in the pixel, as shown in FIG. 1, and applying the gate driver shown in FIG. 4 and the driving method in which the device is driven with the multiple grayscale display region limited as shown in FIG. 5, the power consumption can be reduced even during digital driving.

FIG. 4 shows an internal structure of the gate driver 11. The gate driver shown in FIG. 4 includes a selection shift register 18 which sequentially selects a gate line by shifting the selection data to the next line in synchronization with the clock, an enable shift register 19 which sets a line in which the output of the gate driver is to be enabled, and an enable circuit (NAND circuit) 20.

In the gate driver shown in FIG. 4, first, enable data and a clock (not shown) are input to an input ENB of the enable shift register 19, and a line in which the output of the gate driver is to be enabled is set. Once all lines are set, no clock is input to the enable shift register 19. With this process, a line of the enable shift register 19 having a value of “1” is set to be selectable by the stored data of the selection shift register 18 while the a line having a value of “0” is not selected regardless of the stored data in the selection shift register 18. With this setting, the line to be selected can be arbitrarily limited (set).

Referring to FIG. 5, a driving method in which multiple grayscale display is realized only in a limited region with the use of the gate driver of FIG. 4 will be described. FIG. 5 shows an example configuration with a frame memory 15 built in to a data driver 12 which can store 7 bits of data for each pixel, and in which a video image stored in a pixel memory array 10 which can store one bit of data for each bit is partially updated.

Of the data of 7 bits, a bit E0 is used for a 1-bit pixel memory display, and the remaining bits D0-D5 are used for multiple grayscale display of 6 bits. In this manner, the frame memory 15 is configured to be able to simultaneously store two types of data.

Here, consider a display method in which, for example, a region A is set as a multiple grayscale display region and a region B is set as a monochrome display region. In this case, the region in which the video image must be updated at all times can be limited to the region A, and thus the power consumption can be reduced compared to a case in which the entire screen is updated.

As describe above, first, data is set in the enable shift register 19 to set a line to be enabled. Here, by setting the lines M to N to “1” and other lines to “0”, it is possible to apply the selection data stored in the selection shift register 18 only to the lines M to N. In other words, even when selection data for updating the entire screen is input to an input STV of the selection shift register 18, only the lines M to N are updated.

Because the region A has a width from P to Q, the data of D0-D5 of the 7-bit memory data are reflected only in this region, and the E0 data is reflected in the other regions. A data selection signal determines which of the two types of data, of E0 and D0-D5, in the 7-bit data read from the frame memory 15 is to be output to the output processor 16. In other word, by setting the data selection signal to Low only between P and Q, D0-D5 are read in this region, and by setting the data selection signal to High in the other regions, E0 data is read. The read data is reflected to the output processor 16.

As a result, multiple grayscale display in a plurality of sub-frames using data of D0-D5 is realized only in a region of columns P to Q from line M to line N, that is, the region A. Because the data of “0” which is set in the enable shift register 19 is input to one input of the enable circuit 20 in regions other than the lines M-N, these regions are not selected at all, and the display is continued with the previous data. In addition, in a region of columns other than the columns P to Q and lines M-N, data is written at a timing similar to the region A, but the same data is rewritten by E0, and as a result, these regions are not updated and display is realized in these regions with the previous data.

Here, it suffices to input the selection data to be input to the selection shift register 18 at a timing of the digital driving when the entire screen is to be updated, and only the lines in which “1” is set in the enable shift register 19 are reflected in the display. During this process, because the data of D0-D5 are not reflected on the display in lines other than lines M-N, output of these data to the data line 7 would result in wasteful power consumption. Thus, as a result of the output processor 16 of the data driver 12 not reflecting the memory data of D0-D5 in the output and outputting fixed data of High or Low, although not actually written, at the timing of selecting lines other than lines M-N, it is possible to reduce a change of data to be output to the data line 7, and consequently reduce power consumption due to a change of data which is not reflected to the display.

As described, by introducing the enable shift register 19 in the gate driver and connecting the output of the enable shift register 19 to an input of the enable circuit 20 so that the output of the gate driver is programmably activated and deactivated, it is possible to limit the region in which multiple grayscale display is to be realized. In particular, by applying the setting before display is started, it is possible to arbitrarily set the multiple grayscale display region, and thus it is possible to apply a partial update process with a higher degree of freedom while using the sequentially scanning gate driver.

In addition, because display can be updated while limiting a region, rewriting of data in a region in which a monochrome display is to be continued is not necessary, and thus the power consumption can be reduced. In many of various screens in a portable device such as an input screen, there are monochrome display regions in which update is not necessary, and the device of the present embodiment may be suitably applied.

In the pixel of monochrome display, display by data E0 is realized in one frame period, and display is continued for a plurality of frames when the display is not updated. In a monochrome display pixel connected to a gate line in a region selected by the gate driver, the same data is repeatedly written. In the pixels of multiple grayscale display, on the other hand, data D0-D5 are sequentially supplied for each sub-frame and display is controlled in each sub-frame.

The invention has been described in detail with particular reference to certain preferred embodiments thereof, but it will be understood that variations and modifications can be effected within the spirit and scope of the invention.

### Parts List

1 element
2 first driving transistor
3 element
4 second driving transistor
5 gate transistor
6 gate line
7 data line
8 power supply line
9 cathode electrode
10 pixel memory array
11 gate driver
12 data driver
13 pixels
14 input processor
15 frame memory
16 output processor
17 panel
18 selection shift register
19 enable shift register
20 enable circuit

1. An active matrix display device having a plurality of pixels arranged in a matrix form and in which data is supplied to a data line of each column by a data driver, wherein data capturing from a data line in a pixel of each row is controlled by controlling a selection line using an output of a selection driver, to supply data to each pixel and produce a display, and wherein the selection driver comprises:
a sequential scanning driver which sequentially selects the selection line of each row, and includes a storage unit which stores data for setting a predetermined region in which a multiple grayscale display is to be realized, and means for selecting a region in which display data are to be updated are stored in the storage unit predetermined region prior to starting the update of the display, and only outputs of the selection driver for the predetermined region are activated, and data are supplied to the pixels.

2. The active matrix display device according to claim 1, wherein:
data supplied to the data line is digital data, and a multiple grayscale display is realized in the region in which the display is to be updated.

3. The active matrix display device according to claim 1, wherein:
the storage unit comprises a register which stores data corresponding to each selection line; and
the control means includes a gate which activates or deactivates an output from the selection driver to a corresponding selection line according to data in each register.

4. The active matrix display device according to claim 3, wherein:
the storage unit is a shift register, and data is sequentially transferred and set in a register corresponding to each selection line.

5. The active matrix display device according to claim 1 wherein:
each pixel comprises a static memory, and can retain data which is written.

6. The active matrix display device according to claim 1, wherein:
each pixel comprises an organic electroluminescence element as a light emitting element.
